(19) United States
(12) Patent Application Publication
(10) Pub. No.: US 2013/0232157 A1
(43) Pub. Date: Sep. 5, 2013

(54) SYSTEMS AND METHODS FOR PROCESSING UNSTRUCTURED NUMERICAL DATA

(71) Applicant: Tammer Eric Kamel, Toronto (CA)

(72) Inventor: Tammer Eric Kamel, Toronto (CA)

(21) Appl. No.: 13/412,374

(22) Filed: Mar. 5, 2012

(51) Int. Cl. G06F 17/30

(52) U.S. Cl. 707/755; 707/E17.009

(57) ABSTRACT

The field of the invention relates to systems and methods for processing unstructured data, and more particularly to systems and methods for indexing and presenting numerical data sets. In one embodiment, a computer-implemented method for processing unstructured data includes the steps of retrieving one or more raw data sets from a data network; extracting relevant information from each set of raw data; populating a structured table using the extracted information; and refining the structured table for further processing or publishing.

### FIELD OF THE INVENTION

The field of the invention relates to systems and methods for processing unstructured data, and more particularly to systems and methods for indexing and presenting numerical data sets, such as by mapping unstructured numerical data into a single structured format.

### BACKGROUND OF THE INVENTION

A number of information retrieval systems are utilized for electronic search engines based on, for example, indexing algorithms, document representation, query analysis/modification, and so on.

In the context of the Internet and the World Wide Web (“web”), conventional search engines attempt to return relevant web pages based on a user's search query, typically specified as a text string. One approach matches the terms of a user's search query to a set of pre-stored web pages and further orders the results based on a ranking system. Thereby, the web is effectively indexed through text-based keywords where pages containing the search terms are marked relevant and sorted.

Alternative methods improve search engine results to include numerical data. For example, U.S. patent application Ser. No. 12/863,977, Pub. No. U.S. 2010/0299332 A1, filed Feb. 6, 2009 to Dassas et al., for “A Method and System of Indexing Numerical Data,” which is hereby incorporated by reference in its entirety, discloses a system and method for indexing numerical information embedded in one or more image files. This technique allows users to search for numerical data, such as graphs, charts, and tables, in addition to text-based data. Although improved search engines cast a wider net for relevant documents, the standard approach continues to catalog the web using text-based keywords that describe the numerical data. Indexing the web is most effective for locating relevant documents; however, the documents are delivered exactly as they were published with only limited immediate usability.

Search engines rarely provide the specific answer to a user's search query, but rather offer the documents and pages that may contain the answers. The result of a search query is often a pointer or link to the relevant web page. Modern search engines—for example, Google®, Yahoo®, and Bing™—respond to user's questions or keywords with “raw” Internet resources in their native format. Therefore, a considerable burden is placed on a user to read through significant amount of information in a variety of native formats. The user must manually process these documents and pages to obtain the specific information sought.

Manually sorting through an extensive amount of numerical data consumes expensive and valuable resources. As is well known, the Internet's rapid growth has generated a wealth of information shared by organizations in almost every industry. More than 2 billion web pages have been created over the last decade with millions of pages being added each month. The volume of potentially usable business information on the web would benefit from summary analysis to alleviate the time spent understanding raw numerical data.

In one example, a user may want to visualize a time series of historical gold prices and oil prices. Unfortunately, this information may not be readily available on any single web page. Instead, numerical data reflecting historic gold and oil prices may arbitrarily exist across several web pages in a plurality of data sets. An attempt to build a single time series of numerical data that can be found on the web requires manual calculation that conventional tools are unfit to handle. As discussed, conventional search engines can lead a user to these various data sets. This can assist in the collection of relevant data (e.g., keyword indexing to locate historical gas and oil prices in the example above); however, the results often not only are isolated from one another but also are combined with irrelevant data.

Finding all appropriate data sets, extracting specific information, converting each to a usable format, and merging all sets into a single source take time. Once compiled, the data, then, can be analyzed and published in a number of formats (e.g., graphs, tables, delineated files, and so on) to uncover an explicit answer to a search query. Current tools fall short of dynamically processing and merging relevant data into a usable format.

Although some data on the web exist in pre-processed form (e.g., formatted, extracted, integrated, and consolidated), these static data sets are a minority of the web's data and afford limited functionality (e.g., restricted visualization and access tools). For instance, a user can view published numerical U.S. government data (e.g., average consumer food prices by nation) as graphs or charts. However, these visualization tools not only assume a pre-centralized numerical data source, but also grant users read-only capabilities. Where the data sets to be found are not already integrated and published in usable form, manually reading through lengthy prose to uncover and consolidate useful numerical statistics may be inaccurate and time-consuming.

For a majority of the data on the web, solutions for processing distributed raw data is further complicated by unstructured data. Most electronic information on the web today is stored and published in unstructured form—that is, information that does not have a pre-defined data model. This type of data does not fit well into relational tables or databases. The irregularities and ambiguities resulting from the unstructured information make it difficult for machine-processable solutions to understand specific content.

Unstructured data can exist in many forms and is well understood to include e-mails, text documents, PowerPoint presentations, delimited files, and so on. However, unstructured data may also include semi-structured data, which is a combination of structured and unstructured data. The main content of semi-structured data does not have a defined structure, but comes packaged in objects that themselves have structure (e.g., a HyperText Markup Language (HTML) page or Extensible Markup Language (XML) page tagged for rendering). While many documents follow defined formats, they may also contain unstructured portions or make up a larger unstructured document.

Recent studies estimate that over 80% of all usable business information originates in unstructured form. In many occasions, this usable business information is non-text data, specifically, numerical data such as graphs, charts, tables, and so on. As briefly discussed in the example above, this numerical data is arbitrarily scattered over thousands of web sites in hundreds of various formats. The variety of published formats available on the web would require a virtually limitless number of individualized applications to process each unstructured document.

One solution for understanding unstructured data sets converts the raw information into structured blobs. An example is disclosed in U.S. Pat. No. 7,599,952, to Parkinson et. al, filed Sep. 9, 2004, for a “System and Method for Parsing Unstructured Data into Structured Data,” which is hereby incorporated by reference in its entirety. This method uses a statistical parse to map unstructured input data into a pre-defined model. Specifically, a system is contemplated that uses a machine-learned statistical model to generate structured data blobs from various inputs.

Unfortunately, while this method is effective for text-based queries, numerical queries create additional difficulties for existing solutions that do not distinguish numbers and letters. Techniques that can generate structured data improve the format of existing data sets, but may not understand the content that is retrieved, indexed, or converted. These solutions fail to process and extract only the relevant data (e.g., divorcing prose from numerical data) to accurately respond to a user's query. Moreover, once the data is extracted and merged, current publishing and visualization solutions only apply to a small set of the web's data and deliver the information in limited formats. Accordingly, an improved system and method for retrieving and processing unstructured numerical data in a network-based environment is desirable.

### SUMMARY OF THE INVENTION

The field of the invention relates to systems and methods for processing unstructured data, and more particularly to systems and methods for indexing and presenting numerical data sets. In one embodiment, a system for indexing unstructured numerical data may include a database for storing processed numerical data sets. The database is operatively coupled to a computer program-product having a computer-usable medium having a sequence of instructions, which when executed by a processor, causes said processor to execute a process that analyzes and converts unstructured numerical data sets over a data network.

The computer-implemented method for processing unstructured data includes the steps of retrieving one or more raw data sets from the data network; extracting relevant information from each set of raw data; populating a structured table using the extracted information; and refining the structured table for further processing or publishing.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a schematic diagram of a network environment in accordance with a preferred embodiment of the present invention.

FIG. 2 is a flowchart of a process in accordance with a preferred embodiment of the present invention.

FIG. 3a is a flowchart further detailing a step of the process shown in FIG. 2 in accordance with a preferred embodiment of the present invention;

FIG. 3b illustrates one embodiment of a semi-structured numerical data set.

FIG. 4 is another flowchart further detailing a step of the process shown in FIG. 2 in accordance with a preferred embodiment of the present invention.

FIG. 5 illustrates one embodiment of a structured data array.

FIG. 6 illustrates a refined data array in accordance with one embodiment of the present invention;

FIG. 7 is a sample screenshot publishing the refined data array in accordance with one embodiment of the present invention; and

FIG. 8 illustrates preferred derivatives of a structured data array according to the present invention.

### DETAILED DESCRIPTION OF THE PREFERRED EMBODIMENTS

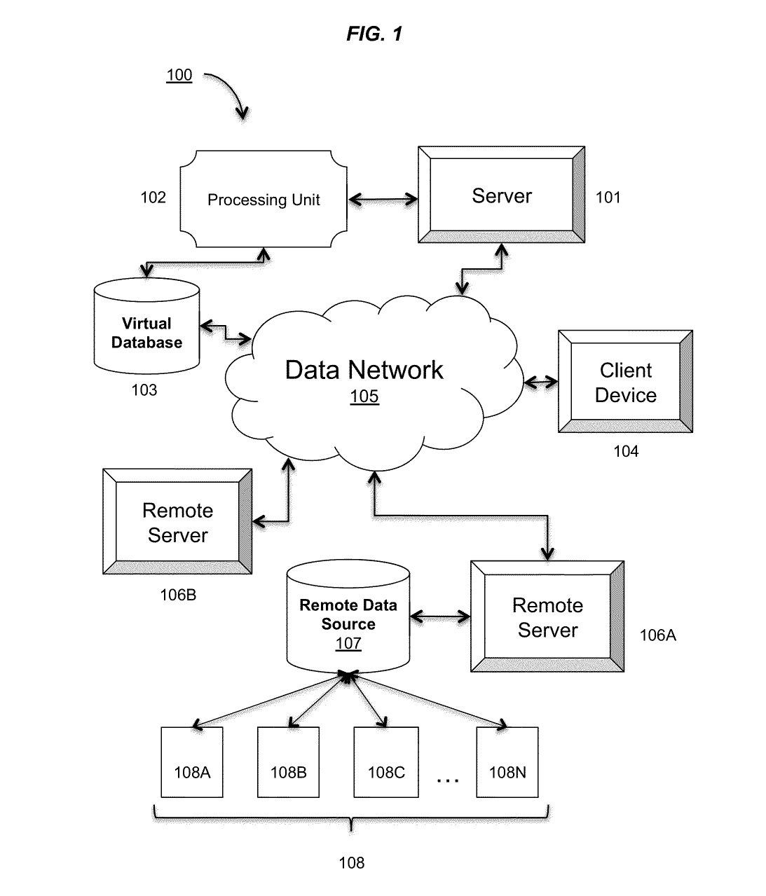

As described above, files and documents containing both unstructured and structured data are arbitrarily scattered over thousands of web sites in hundreds of various formats. This information is typically stored on heterogeneous computer systems connected to a distributed network, such as illustrated in FIG. 1. An exemplary network system arrangement 100 for use with the present invention is shown. The environment 100 has a plurality of remote server computers 106A, 106B . . . connected to data network 105 through respective network connections. These network connections are wired or wireless and are implemented using any known protocol. Similarly, data network 105 may be any one of a global data network (e.g., the Internet), a regional data network, or a local area network. The network 105 may use common high-level protocols, such as TCP/IP and may comprise multiple networks of differing protocols connected through appropriate gateways.

Remote server 106A may include a storage device 107 for storing electronic data files 108, for example, files 108A, 108B, 108C and 108N. While each remote server 106A, 106B . . . can host any unique number or type of electronic files accessible over data network 105, server 106A is shown in more detail for illustration purposes only. As one of ordinary skill in the art would appreciate, storage device 107 may be any type of storage device or storage medium such as hard disks, cloud storage, CD-ROMs, flash memory, DRAM and may also include a collection of devices (e.g., Redundant Array of Independent Disks (“RAID”)). Similarly, it should be understood that remote server 106A and data source 107 could reside on the same computing device or on different computing devices.

Data source 107 is shown to store N file types. These files 108 may include, but are not limited to, text documents, tables and graphs, image files containing mostly graphics, image files containing text and numerical data, multimedia files, portable document format (“PDF”) files, a mixture of these file types, and so on. Each file contains structured, unstructured, or a combination of both data types. These file types are often found as a combination, for example, as a web page or HyperText Markup Language (“HTML”) document that make up a larger web site. A web page may also include embedded data and provide links to other data formats located on data source 107. In order to access files 108, a Uniform Resource Locator (“URL”) is used in one embodiment to specify a network address of the files 108 stored in data source 107.

Server 106A controls access to the files 108 located in data source 107. Accordingly, a user connected to data network 105 through client device 104 requests access to files 108. The connection between data network 105 and client device 104 is often provided through an Internet Service Provider (ISP). Client device 104 includes, but is not limited to, laptops, desktops, cellular phones, personal digital assistants (PDA), multiprocessor systems, microprocessor-based systems, programmable consumer electronics, telephony systems, distributed computing environments, set top boxes, and so on.

Conventional search engines based on keyword or phrase queries can direct users to files 108. For example, users of client device 104 access a search engine (e.g., Google®) through an Internet browser (not shown) running on device 104. The users then enter search queries into device 104 through input devices (not shown) such as keyboards, microphones, pointing devices, scanners, game pads, and the like. Conventional search engines compare keywords of the query to keywords describing a file on the data network and if a match is found, the search engine will display the file or a link to the file in its original format. Alternatively, users of client device 104, for example, can access files 108 directly through a known URL of a specific file.

As mentioned above, once the files are located, the data is typically presented in its native format. Using a direct URL, a file will be shown in its published format. A search engine returns links to files in their published format. Although relevant web pages are located, extracting specific data from each page to consolidate and present accurate responses to a user query is a manual process that allows for human error.

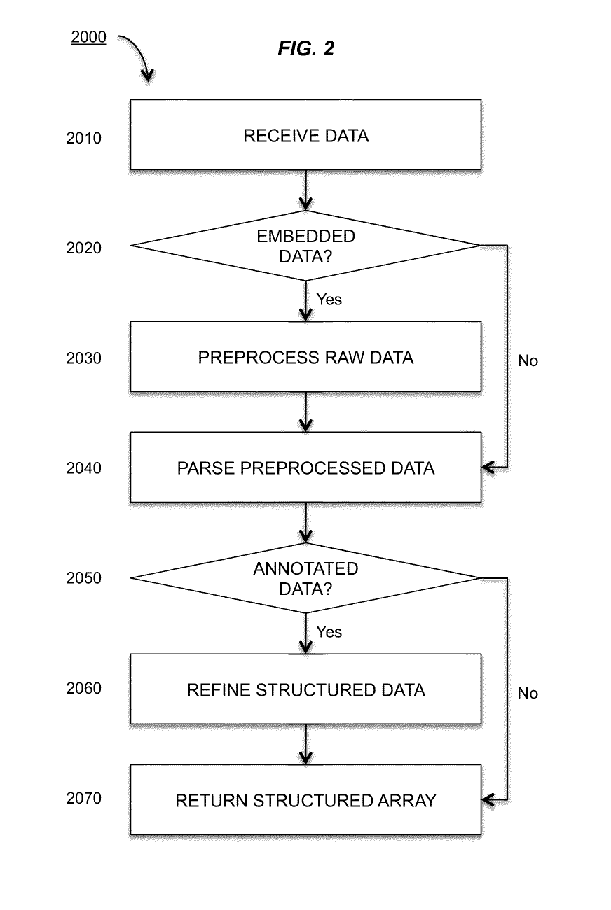

One approach to address this issue is shown in FIG. 2, which illustrates a process 2000 for enabling a user to dynamically search for usable answers from web-based content, such as electronic files 108. Process 2000 may consist of various program modules including routines, programs, objects, components, data structures, and so on that perform particular tasks or implement particular abstract data types. In a distributed computing environment, these modules are located in both local and remote storage devices including memory storage devices.

In a preferred embodiment, with reference to FIG. 1, server 101 provides a computer system having a processor 102 configured to execute process 2000. In one embodiment, server 101 connects to data network 105 and implements known protocol (e.g., HyperText Transfer Protocol (“HTTP”)) commands to access network-based content, such as electronic files 108. Accordingly, server 106A is configured to resolve known protocol requests to access files 108 over data network 105. Server 101 accesses data network 105 through wired or wireless connections using any known protocol.

Processing unit 102 centrally stores processed data including internal resources and variables in database 103. In some embodiments, database 103 may be any type of storage device or storage medium such as hard disks, cloud storage, CD-ROMs, flash memory, DRAM and may also include a collection of devices (e.g., Redundant Array of Independent Disks (“RAID”)). In other embodiments, a virtual database system comprising storage containers to integrate data from multiple data sources may be used. These virtual database systems decouple the physical implementation of database files from the logical use of the database files by server 101.

Server 101 may further include a user interface console, such as a touch screen monitor (not shown), to allow the user/operator to preset various system parameters. User defined system parameters may include, but are not limited to, electronic file import specifications, preprocessing variables, file formats, and filtering criteria.

Turning back to FIG. 2, process 2000 begins with a request for an electronic file (starting block 2010). Given the URL of a specific file, a client submits a request to retrieve the data from that location. In a preferred embodiment, a standard networking protocol (e.g., HTTP, HTTP Secure (“HTTPS”), File Transfer Protocol (“FTP”)) request is used to access the files 108. The server storing electronic files provides resources in response to a client request. This response contains completion status information about the request and the requested content.

The electronic file may contain structured, unstructured, or a combination of both data types, such as files 108. Depending on the original format of the requested file—for instance, the native format of files 108—the server returns a block of data from the requested page. This block of data is typically text or binary data (e.g., an excel file), but may contain image data (e.g., graph). Furthermore, the block of data may be represented in various languages (e.g., Arabic, English, Chinese, Japanese, and so on).

In an alternative embodiment, a client device may be configured to include an HTTP POST request in starting block 2010. This request may be used when submitting additional data to the web server as part of the request for a file. In contrast to only retrieving data, a POST request optionally provides for uploading and storing information, such as completed forms or file uploads. The advantages of an HTTP requests are well understood and appreciated.

Once a block of data is gathered from a URL, the relevant portion of data is often embedded within additional non-numerical data (decision block 2020). For example, a web page may augment a table of usable numerical information with additional lines of html code, such as in a semi-structured html page. Furthermore, the data may also be encoded for processing unit 102 to decode. Accordingly, this collected information can be prepared for processing (action block 2030).

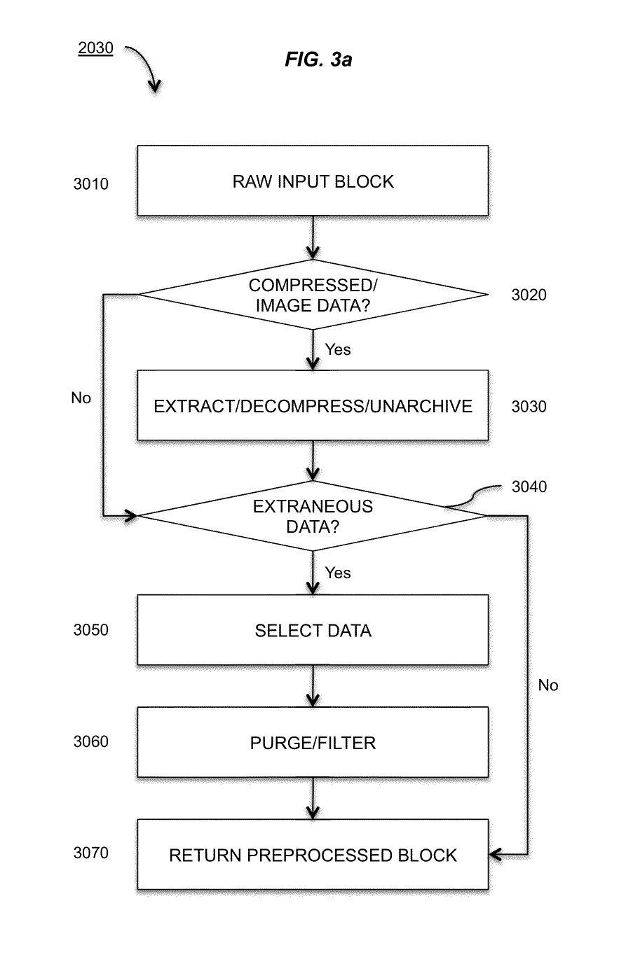

FIG. 3a illustrates processing block 2030 in further detail. Starting with the raw data (starting block 3010), if the numerical contents are compressed, archived, or embedded in an image (e.g., graphs, charts) (decision block 3020), the data blocks are first decompressed and extracted (action block 3030). As one of ordinary skill in the art would appreciate, data compression encodes bits of information using a fewer number of bits than in the original file to reduce memory and transmission resources. Various systems and methods for file archive and compression are well known in the arts of computing and network technology. For example, lossy compression methods are commonly used to compress multimedia data (e.g., digital images, digital video discs (“DVDs”), audio components) and lossless compression schemes are often used for text and data files (e.g., ZIP, GZIP). Further description of data compression and alternative schemes can be found, for example, in Request for Comment (“RFC”) 3284, a public Internet document disclosing compression and differencing techniques, which is also incorporated by reference in its entirety.

In addition to data compression, the raw numerical data in starting block 3010 may be embedded in an image file (decision block 3020). Accordingly, processor 102 extracts the numerical data from these graphs and charts and converts the data block into a table format (e.g., xml, standard text, html). In one embodiment, images are converted to a vector-based graph or chart in order to determine numerical values based on reference points of the data. Image processing solutions are well understood and appreciated to those skilled in the art.

Once the data is extracted, the contents of the raw data are subsequently cleaned and processed to remove extraneous information that might decrease the value of the data. Specifically, extraneous data is any information that does not explicitly address a user's search query. In the gold and oil price example from above, a user is interested only in numerical gold or oil prices, such as the data shown in FIG. 3b. However, often this table is a small portion of a larger web page with additional lines of text, images, links, and so on. Therefore, extraneous information consists in part of the html code (e.g., navigational hyperlinks and descriptive text) outside of the table illustrated in FIG. 3b (not shown). Extraneous information also includes common formatting errors. For example, an extraneous field delimiter (e.g., additional or misplaced comma in a CSV file) can be purged or corrected in this step. These corrections ensure valid file formats for further processing. Alternatively, user input to server 101 can be used to define extraneous information and alternative criteria to select or purge from the data block.

Turning back to FIG. 3a, if the block of data contains any extraneous information (decision block 3040), only relevant data is selected (action block 3050) and extraneous information is purged (action block 3060). The server then returns a smaller block of data containing only applicable information in a valid file format (end block 3070). As illustrated in FIG. 3b, lines of text outside of the table are purged and only the table of information is returned. Therefore, the process 2000 provides the advantage of reducing manual filters for usable data immersed in a wealth of irrelevant information.

After the extraneous information is purged, a user may benefit from further interpretation of the usable data. For example, a user of client device 104 may want to view a set of numerical results as a table or a graph. However, machine-processable data typically exists in structured form in order to reduce the variables needed for processing. Although FIG. 3a illustrates a single embodiment of a semi-structured table, one of ordinary skill in the art would appreciate that identical data is often presented in similar, but unique formats (e.g., CSV, XML and so on). Conventional tools, for publishing or visualizing data, for example, often cannot cover the full range of possible inputs and formats associated with unstructured and semi-structured data. Process 2000 regulates the structure for exchanging information.

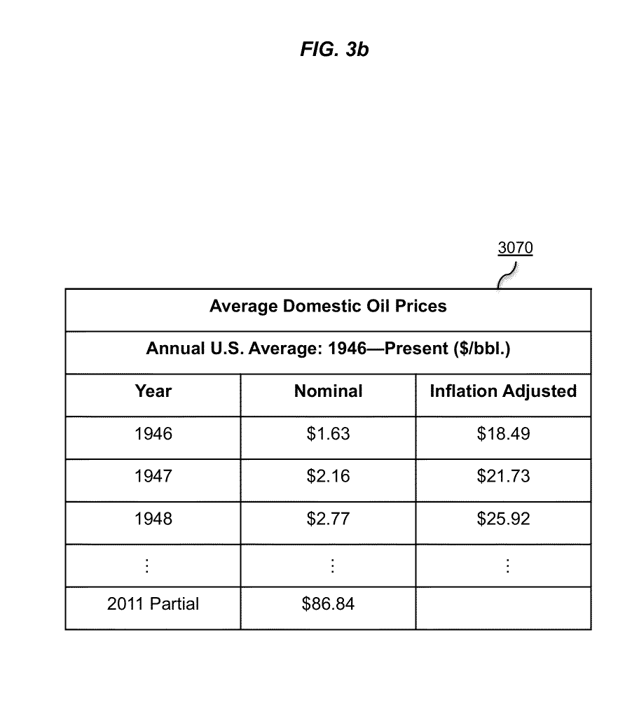

With reference to FIG. 2, in light of the above, process 2000 scans and maps usable data obtained in action block 2030 to provide a single structured format (action block 2040). FIG. 4 illustrates processing block 2040 in further detail. Starting with the preprocessed block of data (starting block 4000), processor 102 determines the proper procedure for syntactic analysis of the data based on its file format. If the format of the data block received in action block 2010 is a spreadsheet (e.g., Microsoft Excel file) (decision block 4010), processor 102 parses the data using the rows and columns of the spreadsheet (action block 4020). For each row and column of the spreadsheet containing relevant data, processor 102 generates tokens from each cell. As one of ordinary skill in the art would appreciate, the parsing method may be top-down or bottom-up, and includes recursive parsers. Parsing and similar syntactic analysis techniques are well known to those skilled in the art. The generated token is stored in a structured array (action block 4090).

As an alternative, if the format of the data block uses delimiter-separated values (decision block 4030), processor 102 parses the information according to the specific delimiter (action block 4040). For example, commas, tabs, spaces, colons, or other characters may be used to delimit data values, such as in commas-separated values (CSV) files or tab-separated value (TSV) files. For each separated value, tokens are generated and stored in a structured array (action block 4090).

Similarly, if the data block is encoded using XML (decision block 4050), processor 102 parses the information according to the markup-delineation (action block 4060). For example, processor 102 may parse each cell within an XML table element (e.g., data within <table> tags). For each separated value, tokens are generated and stored in a structured array (action block 4090). The format of the data block may also be encoded using HTML (decision block 4070) and is similarly parsed according to the appropriate HTML element (action block 4080). Each tokenized data value is then stored in a structured array (action block 4090). FIG. 4 is shown to support preprocessed input blocks in standard text (e.g., delimited files), spreadsheets, xml, and html file formats. However, as one of ordinary skill in the art can appreciate, alternative file formats—including, for example, portable document formats (PDF's), Microsoft Word files, Excel files, JavaScript Object Notation (JSON) files, ordered tuples, and so on—can be similarly analyzed according to their respective field formats.

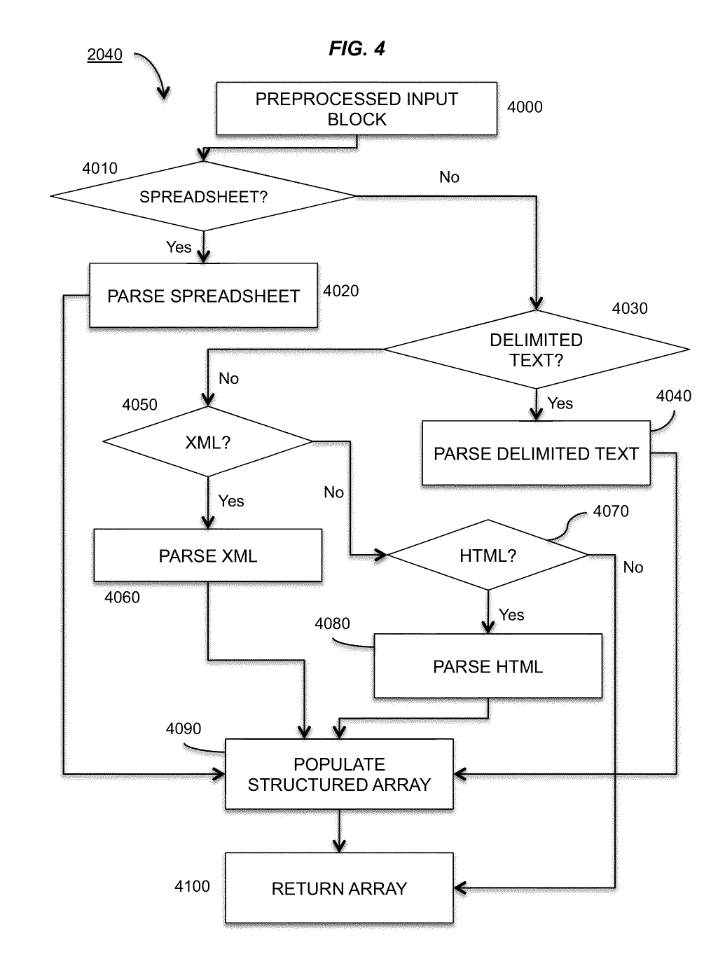

With reference to FIG. 3b, this table may be found as a spreadsheet or encoded using xml/html, for example. Processor 102 uses the format of the data to generate tokens for each cell in the table. Specifically, processor 102 generates a token for each header, year, nominal price, and inflation price. These tokens are stored in a structured array, such as illustrated in FIG. 5.

Once the array is populated using data in its native format, the result is a structured data set in a cleaner, standard format (result block 4100). Consequently, the structured data can be input for traditional computer-based processing solutions (e.g., visualization tools). FIG. 5 is a sample, structured array of the data shown in FIG. 3b as a result of action block 2040 (see also result block 4100). As illustrated, FIG. 5 implements an associative array 4100 that maps the years to their respective oil prices.

In one embodiment, array 4100 uses a mapping function to map identifying keys (e.g., year) to their respective values (e g., annual average oil price and inflation information). FIG. 5 shows a hash table where a hash function is used to transform the keys into a hash index of its corresponding array element (i.e., bucket). Hash tables, hash maps, and similar unordered maps are data structures that are well understood to those of ordinary skill in the art. However, it should also be appreciated that the structured array may be any similarly associated data structure or data type configured to maintain structural consistency.

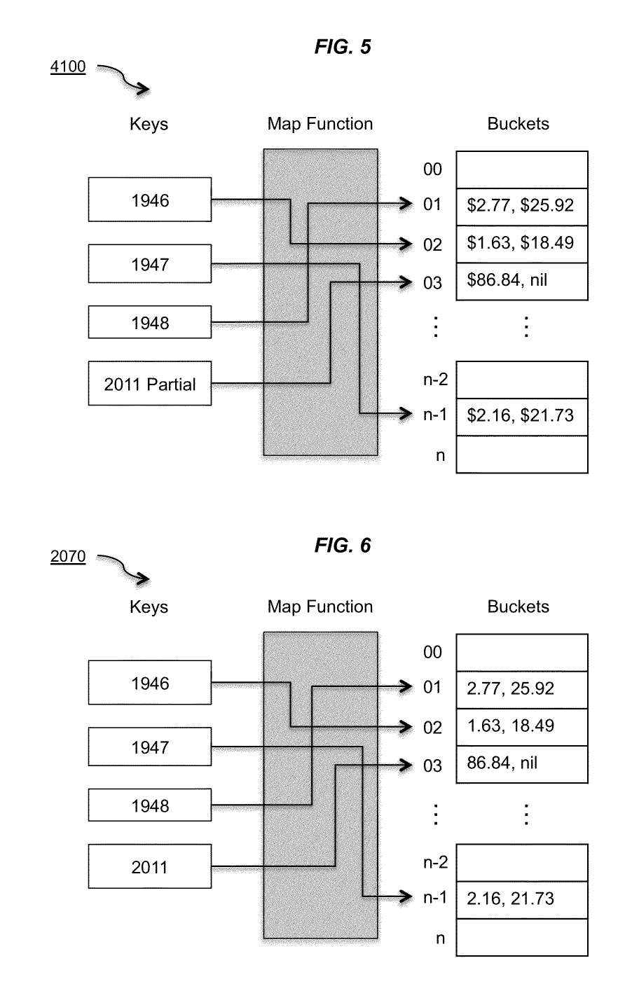

Turning back to FIG. 2, the structured array may still be annotated with irrelevant non-numerical data that was not purged during preprocessing block 2030 (decision block 2050). Therefore, similar to preprocessing block 2020, the structured array further can be refined to remove any remaining non-numerical data (action block 2060). Where preprocessing block 2020 purged all information outside of the numerical table, refining block 2060 fine-tunes the structured array to remove any non-numerical information within the table following the final parse. Specifically, this includes removing/selecting array entries, modifying the order of the array, transposing the data structure, and so on. Alternatively, user defined parameters may be used to refine the data structure. With reference to the mapping in FIG. 5, non-numerical information from the keys (i.e., the text “Partial”) as well as the array elements (i.e., “$”) are filtered from the final structured array. This normalized array is shown in FIG. 6.

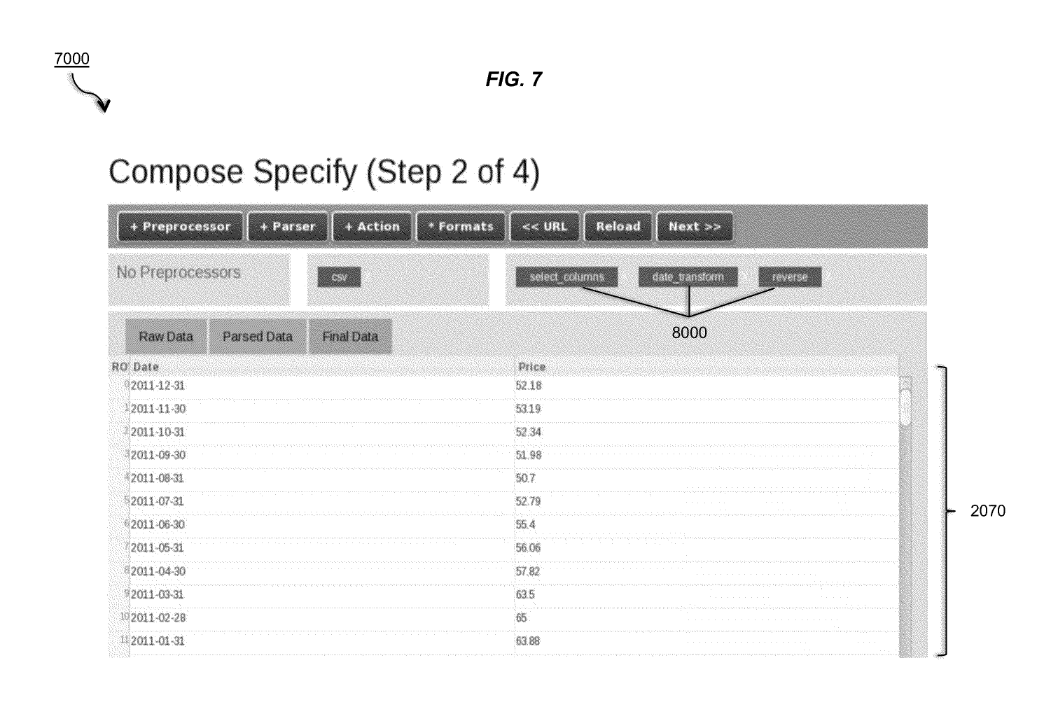

As illustrated, the data structure is ideal for further processing and returned in action block 2070. A sample screenshot 7000—viewed from a browser on client device 104, for example—displaying the normalized array 2070 is shown in FIG. 7. This structured data set can be stored/cached in database 103 to provide a centralized source of numerical data in a common format for a user of device 104. Regardless of the native format of files 108, a searchable, consolidated source can be seamlessly summarized or analyzed to suitably respond to the user's numerical query.

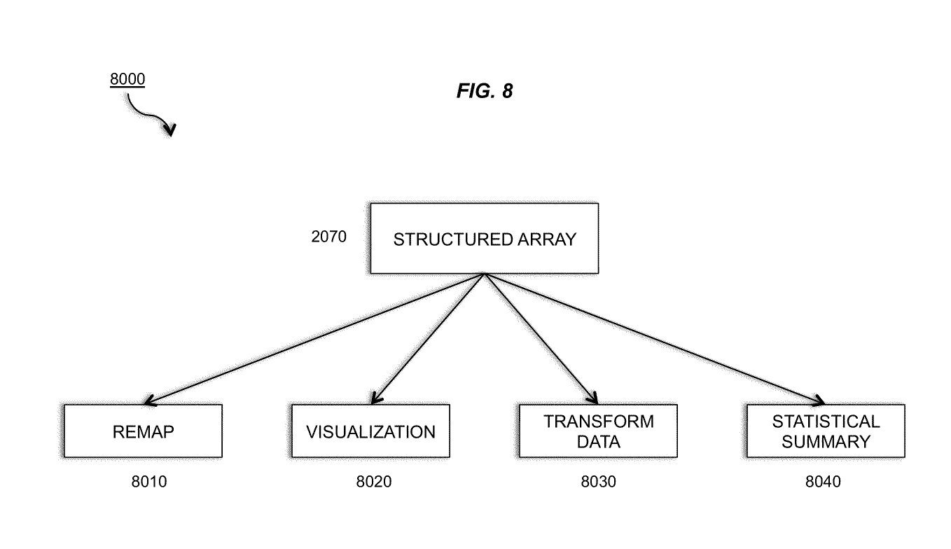

As an example, sample options for summary analysis 8000 of the normalized array are shown in screenshot 7000 (i.e., selecting specific columns, transforming data, and reversing the data set). FIG. 8 illustrates further summary analysis 8000 of the structured array obtained from process 2000. In one embodiment, the data from the structured array can be mapped to alternative data formats in step 8010. Alternative data formats include, but are not limited to, standard text (e.g., delimited files), spreadsheet, Excel, Word, HTML, PDF, XML, JSON, and ordered tuples. Remapping the numerical data provides a user with multiple presentation options of the structured information.

In fact, the numerical data not only can be presented in various numerical formats, but also can be presented graphically in step 8020. As previously discussed, using the data in a structured array, processor 102 renders visualizations from the numerical data sets. The visualization process includes generation of time series charts (e.g., line graphs, columns), rank comparison charts (e.g., bar graphs), frequency distribution charts (e.g., histograms, histographs), correlation charts (e.g., scatter plots, bubble plots, paired bar charts), contribution comparison charts (e.g., pie charts, pie series, stacked 100%), status charts (e.g., barometers/thermometers, LEDs), variation charts (e.g., radar, polar, heat maps), other charts (e.g., Bollinger graphs, lists, contour maps, mesh plots, trees), a combination thereof, and so on. In one embodiment, it will be understood by those skilled in the art that processor 102 uses software visualization systems (e.g., recursive algorithms to draw ordered lines, points, and surfaces from a structured data query) to graphically represent the structured numerical data. Accordingly, these graphs facilitate a user's interpretation of numerical results in order to better target the user's data query.

In an alternative embodiment, the data from the structured array can be further transformed in step 8030. Specifically, the numerical data set can be transformed into a second data set using mathematical transformation functions. These transformations allow users to benefit from a comparative analysis of individual values from the numerical data sets. For instance, a user analyzing numerical data reflecting Gross domestic product (GDP) may want to evaluate the period-by-period change, percentage change, sum, sum by period (e.g., quarterly total from daily data). Therefore, the difference—or percent difference—between successive entries in a particular GDP data set is often more interesting/valuable to the user than the values of the entries themselves. Processor 102 applies mathematical formulas to portions of the data to create a transformed data set. Alternatively, user input can be used to define custom mathematical transformations.

Similar to mathematical transformations, a statistical summary of the data in the structured array can be derived in step 8040 without a transformation to a second data set. For example, a user's numerical query may require the mean/average, standard deviation, kurtosis, skew, correlation, and similar mathematical theory/probability measurements. Processor 102 summarizes the numerical data from the structured array and creates additional data fields for the statistical summaries.

As discussed above, a centralized source of numerical data in a common format is ideal for creating a plurality of analysis and presentation options, such as those illustrated in FIG. 8. Process 2000 offers a method for consolidating a wealth of numerical data in various formats. Using the structured array obtained from process 2000 to create several derivations empowers instant and precise responses to numerical queries.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for unstructured numerical data sets, such as web-based tables or spreadsheets; however, the invention can be used for any numerical data set. Additionally and obviously, features may be added or subtracted as desired. Accordingly, the invention is not to be restricted except in light of the attached claims and their equivalents.

What is claimed is:

1. A computer-implemented method of processing and presenting unstructured numerical data from a data network comprising the steps of:
retrieving one or more raw data files from the data network;
extracting numerical data from each of the one or more raw data files, the extracted numerical data having a file format;
parsing the extracted numerical data based on said file format, wherein parsing generates a plurality of tokens, the tokens representing either a key or a value;
populating a structured table with the plurality of tokens, wherein said structured table maps key tokens to value tokens; and
refining the structured table to include machine-processable data.

2. The method of claim 1, further comprising the step of storing said refined structured table in a database.

3. The method of claim 1, wherein the step of extracting numerical data includes the step of decompressing the raw data file.

4. The method of claim 1, wherein the step of extracting numerical data includes the step of processing an image for numerical reference points.

5. The method of claim 1, wherein the step of extracting numerical data includes the step of purging non-numerical information outside of a table.

6. The method of claim 1, wherein the structured table is an associative two-dimensional array data structure.

7. The method of claim 6, wherein the structured table is a hash map having a hash function.

8. The method of claim 1, wherein the one or more raw data files are accessed at a universal resource locator address.

9. The method of claim 1, wherein retrieving one or more raw data sets includes a network protocol request selected from the group consisting of: (1) HyperText Transfer Protocol (“HTTP”); (2) HTTP Secure (“HTTPS”); (3) HTTP POST; and (4) File Transfer Protocol (“FTP”).

10. The method of claim 1, wherein the step of refining the structured table includes the step of removing non-numerical data within said structured table.

11. The method of claim 1, wherein said extracted numerical data has a file format selected form the group consisting of: (1) spreadsheet; (2) delimited text; (3) extensible markup language (“xml”); and (4) HyperText Markup Language (“HTML”).

12. The method of claim 1, further comprising the step of remapping said refined structured table to an alternative data format.

13. The method of claim 1, further comprising the step of graphically visualizing said refined structured table.

14. The method of claim 1, further comprising the step of applying a mathematical formula to said refined structured table.

15. A system of processing and presenting unstructured numerical data from a data network comprising:
a database, the database operatively coupled to a computer program product having a computer-usable medium having a sequence of instructions, which, when executed by a processor, causes said processor to execute a process that converts said unstructured numerical data to a structured array, said process comprising:
retrieving one or more raw data files from said data network;
extracting numerical data from each of the one or more raw data files, the extracted numerical data having a file format;
parsing the extracted numerical data based on said file format, wherein parsing generates a plurality of tokens, the tokens representing either a key or a value;
populating a structured table with the plurality of tokens, wherein said structured table maps key tokens to value tokens; and
refining the structured table to include machine-processable data.

16. The system of claim 15, wherein said process further comprises storing the refined structured table in said database.

17. The system of claim 15, wherein said structured table is an associative two-dimensional array data structure.

18. The system of claim 17, wherein said structured table is a hash map having a hash function.

19. The system of claim 15, wherein said process further comprises the step of remapping said refined structured table to an alternative data format.

20. The system of claim 15, wherein said process further comprises the step of graphically visualizing said refined structured table.

21. The system of claim 15, wherein said process further comprises the step of applying a mathematical formula to said refined structured table.
